(19) United States
(12) Patent Application Publication
(10) Pub. No.: US 2006/0055372 A1
(43) Pub. Date: Mar. 16, 2006

(54) RECHARGEABLE REMOTE CONTROL AND RECEPTACLE

(76) Inventor: Anthony L. Jackson, Lansing, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/711,366

(22) Filed: Sep. 14, 2004

(51) Int. Cl. H02J 7/00

(52) U.S. Cl. 320/114

(57) ABSTRACT

A rechargeable remote control system having a control module that may be recharged at a charging station located on the device for which it is configured to operate. The system provides a rechargeable remote control system for use in operating an electronic device, such as a television or a stereo, and has a control module having a power element, such as a rechargeable battery, and configured for remotely operating an electronic device and a charge receptacle configured to receive the module. The charge receptacle may either be a stand alone unit or integral to the electronic device for which the module is configured to operate. An optional paging device is also included.

### FIELD OF THE INVENTION

The present invention generally relates to remote controls for televisions and the like and particularly to a rechargeable remote control and receptacle configured to receive and charge the remote.

### DISCUSSION OF RELATED ART

Battery powered remote control devices used for operating electronic devices are well known in the art. However, due to costs of purchasing new batteries as old ones are depleted, some electronic devices have begun using rechargeable batteries. Another common problem for remote control users is misplacing or losing the remote. Another problem is a lack of a warning of low battery power leading to a slow deterioration of remote control functionality.

Thus it is desirable to have a rechargeable remote control for electronic devices built into a charging station within the electronic device. The need for a separate charger is eliminated thereby saving the expense of battery replacement. It is also desirable to have an indicator showing the battery power level.

### SUMMARY OF THE INVENTION

Accordingly, the present invention provides a rechargeable remote control system having a remote control module that may be recharged at a charging station located on the device for which it is configured to operate or within a separate unit.

The present invention provides a rechargeable remote control system for use in operating an electronic device such as a television or a stereo comprising a control module having a power element, such as a rechargeable battery, and configured for remotely operating an electronic device, and a charge receptacle configured to receive the module. The charge receptacle may either be a stand alone unit or integral to the electronic device for which the control module is configured to operate and may be positioned on top, on the side or on the front of the electronic device.

The present invention further provides that the control module include a first contact element and that the charge receptacle include a second contact element. The first contact element and the second contact element are configured to releasably connect the control module to the charge receptacle. The system may also include a battery charge indicator, such as a light or a liquid crystal display power (LCD) bar. It may also employ the use of a paging device that includes an activator, a send unit, a receiving unit, a signal generator, and a signal. The signal may be a light or a sound.

Other features of the present invention will become more apparent to persons having ordinary skill in the art to which the present invention pertains from the following description and claims taken in conjunction with the accompanying figures.

### BRIEF DESCRIPTION OF THE FIGURES

The foregoing features, as well as other features, will become apparent with reference to the description and figures below, in which like numerals represent like elements, and in which:

FIG. 1 is a front perspective view of a television with a charge receptacle of the present invention on its front;

FIG. 2 is a front perspective view of a television with a charge receptacle of the present invention is on its top;

FIG. 3 is a front perspective view of a television with a charge receptacle of the present invention on the side;

FIG. 4 is a front view of a television and a “stand alone” charge receptacle;

FIG. 5 is a front view of a control module with a liquid crystal display bar low battery indicator;

FIG. 6 is a side view of a control module with a liquid crystal;

FIG. 7 is a front view of a control module with a light as a low battery indicator; and

FIG. 8 is a side view of a control module with a light as a low battery indicator.

### DETAILED DESCRIPTION

The present invention provides a rechargeable remote control system for use in operating an electronic device, such as a television, stereo, VCR, DVD, and the like comprising a control module having a power element, such as a rechargeable battery, configured for remotely operating an electronic device, and a charge receptacle configured to receive the module. The charge receptacle may either be a stand alone unit or integral to the electronic device for which the module is configured to operate and may be positioned on top, on the side or on the front of the electronic device.

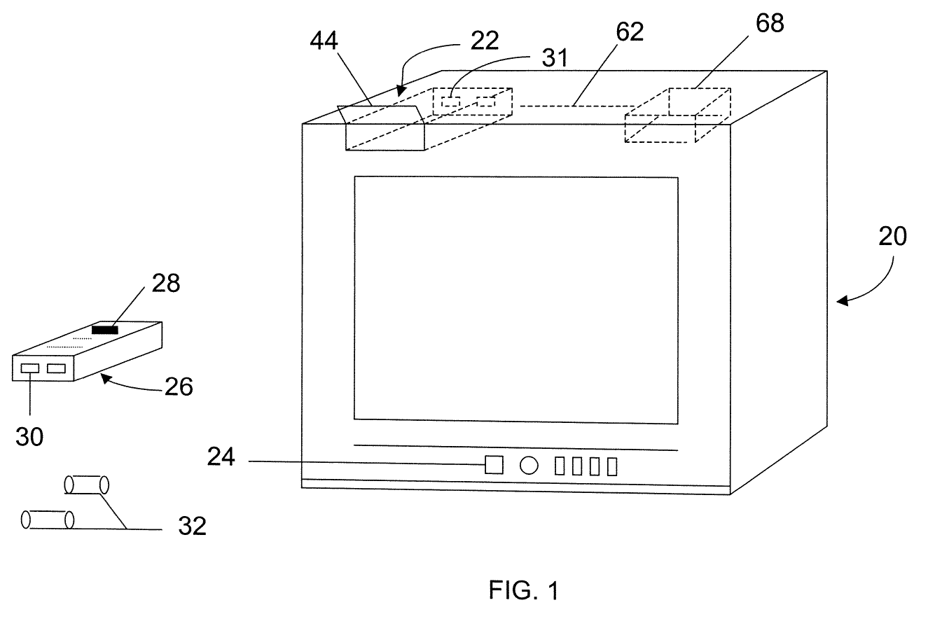

Referring to the figures, FIG. 1 shows the components of a possible embodiment of the present invention. The basic elements of the present invention may include an electronic device, such as a stereo, VCR, DVD or television (as shown at 20), a control module (remote) 26, a cavity (charge receptacle) 22 within the device configured to receive the remote 26, circuitry well known in the art to page the control module 26 (see for example, U.S. Pat. Nos. 5,638,050 and 5,686,891), a pager activation switch 24, a battery charge indicator 28, a first contact element 30, a second contact element 31, and rechargeable batteries 32. Contact element 31 is connected to power source 68 by wiring harness 62.

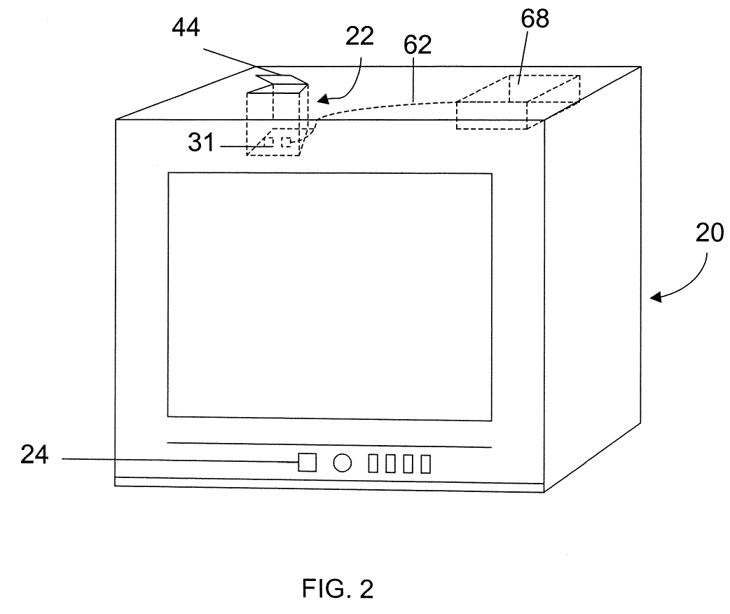

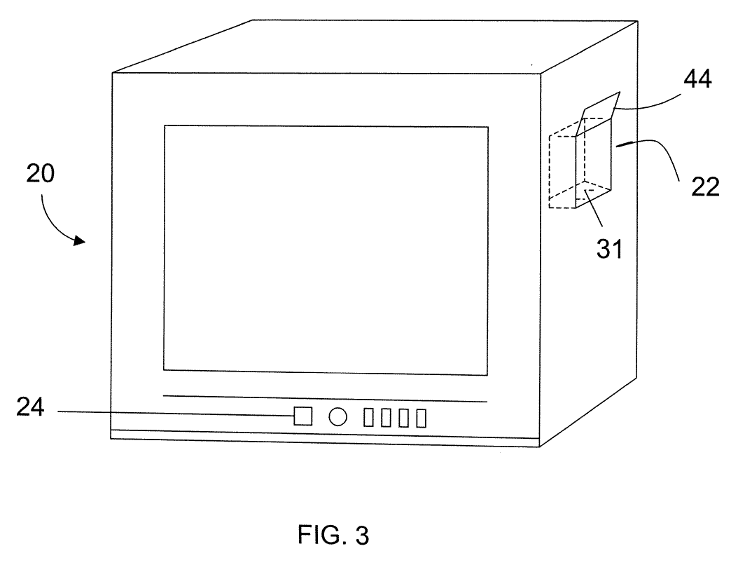

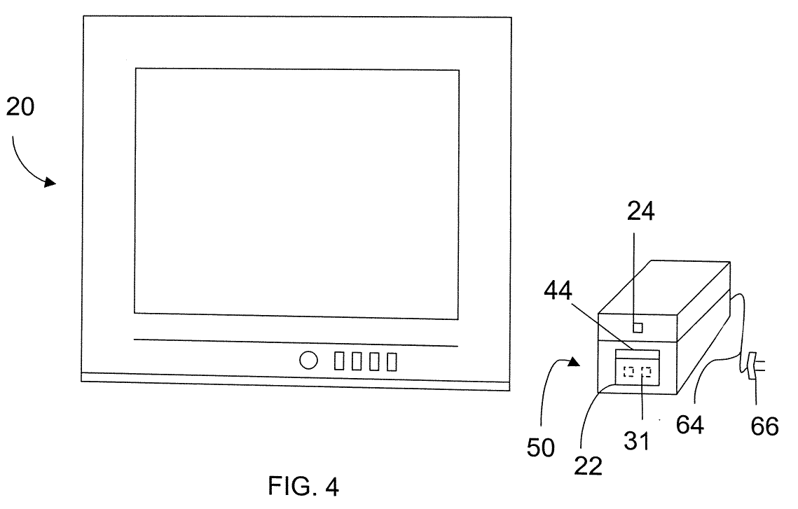

As shown in FIG. 1, the present invention provides that charge receptacle 22 be positioned integrally on the front of television 20. FIGS. 2 and 3 show alternate embodiments where the receptacle's location varies on the top and side of television 20 respectively. Covers may also be added, such as shown at 44. As shown in FIG. 4, the present invention may be easily configured as a stand alone unit in a separate receptacle box 50. This would allow the invention to be added to existing electrical devices using remotes. Again it is noted that a television is used to assist in the understanding of the invention, but any device using a remote control could fall within the scope of the invention.

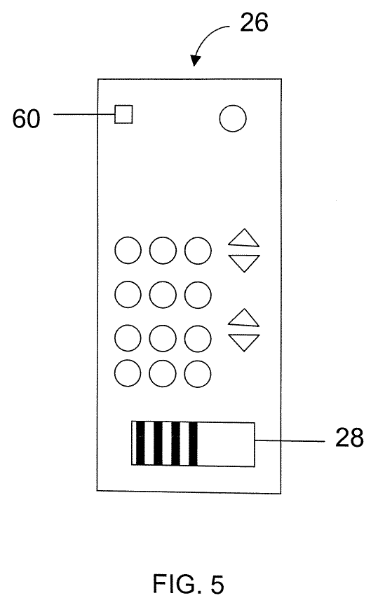

The pager activator switch 24 is part of a paging circuitry known in the art and may have a signal generator circuit disposed within television 20, a signal receiving unit disposed within remote 26 to receive the generated signal, and a pager signal 60 to receive the signal to alert the user of the location of the remote 26. Pager signal 60 may be a light or a sound (see FIG. 5).

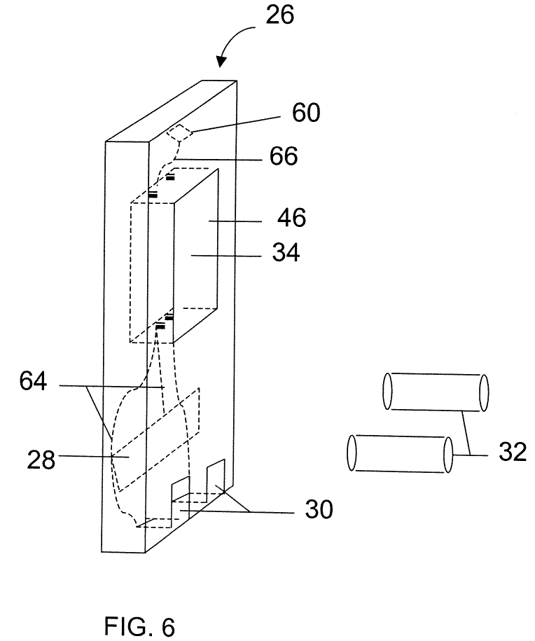

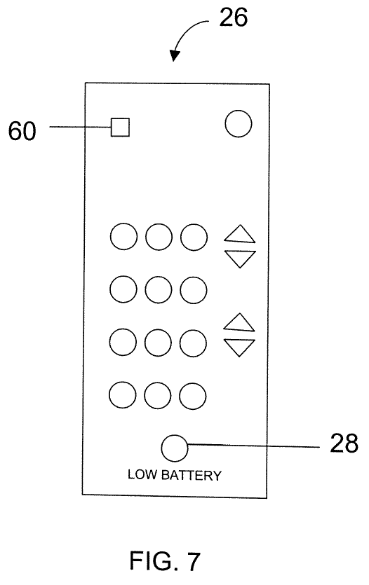

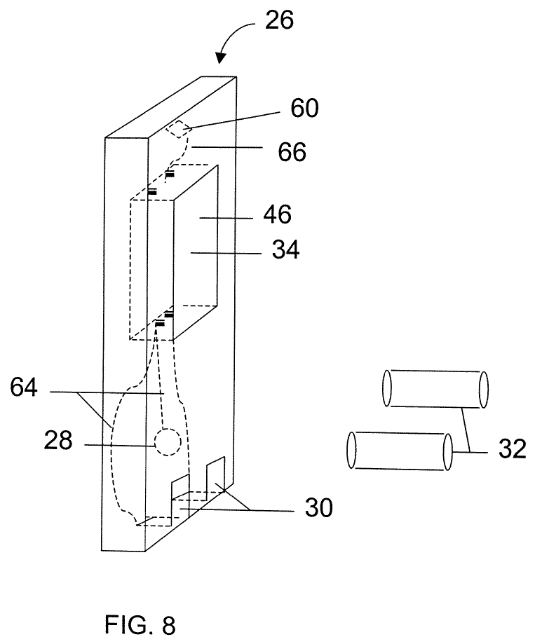

FIGS. 5, 6, 7 and 8 show remote 26 with pager signal 60, a battery charge indicator 28 (LCD bar indicator in FIG. 5, “low battery” light in FIG. 6), a cavity 34 to receive rechargeable batteries 32, a battery cover 46, and first contact element 30. A second wiring harness 64 connects the batteries to battery charge indicator 28 and contact element 30. A third wiring harness 66 connects the batteries to pager signal 60. In use, the present invention could charge batteries 32 by placing remote 26 into charge receptacle 22 until contact is made between first contact element 30 and second contact element 31. A charge to remote 26 is produced through the contact between contact elements 30 and 31. Power comes from wiring harness 62 connected directly to power source 68 in both television 20 as shown in FIG. 1 and in stand alone version of receptacle 22 as shown in FIG. 4. In the embodiment of FIG. 4, pager 24 and related circuitry described above is located on receptacle box 50.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

What is claimed is:

1. A rechargeable remote control system for use in operating an electronic device, comprising:
a control module having a power element and configured for remotely operating an electronic device; and
a charge receptacle configured to receive said control module.

2. The system of claim 1, wherein said charge receptacle is integral to the electronic device for which the control module is configured to operate.

3. The system of claim 2, wherein said charge receptacle is positioned on top of said electronic device.

4. The system of claim 2, wherein said charge receptacle is positioned on the side of said electronic device.

5. The system of claim 2, wherein said charge receptacle is positioned on the front of said electronic device.

6. The system of claim 1, wherein said control module includes a first contact element and said charge receptacle includes a second contact element, said first contact element and said second contact element configured to releasably connect said control module to said charge receptacle.

7. The system of claim 1, wherein said electronic device is a television.

8. The system of claim 1, wherein said electronic device is a stereo.

9. The system of claim 1, wherein said power element is a rechargeable battery.

10. The system of claim 1, further comprising a battery charge indicator.

11. The system of claim 10, wherein said battery charge indicator is a light.

12. The system of claim 10, wherein said battery charge indicator is a liquid crystal display power bar.

13. The system of claim 1, further comprising a paging device.

14. The system of claim 13, wherein said paging device comprises an activator, a send unit, a receiving unit, a signal generator, and a signal.

15. The system of claim 14, wherein said signal is a light.

16. The system of claim 14, wherein said signal is a sound.

17. The system of claim 1, wherein said charge receptacle is disposed within a separate unit from said electronic device to be controlled, said separate unit having an independent power supply from the electronic device to be controlled.
